(19) United States
(12) Patent Application Publication
(10) Pub. No.: US 2017/0360183 A1
(43) Pub. Date: Dec. 21, 2017

(54) WATER BOTTLE 2.0

(71) Applicants: Megan June Macdonald, Etobicoke (CA); Aleksander Majarskii, Etobicoke (CA)

(72) Inventors: Megan June Macdonald, Etobicoke (CA); Aleksander Majarskii, Etobicoke (CA)

(21) Appl. No.: 15/626,003

(22) Filed: Jun. 16, 2017

Related U.S. Application Data
(60) Provisional application No. 62/351,186, filed on Jun. 16, 2016.

(51) Int. Cl. A45F 3/16; F21V 23/04; F21S 9/00; B65D 23/10; B65D 43/02; F21V 33/00; B65D 55/16; F21Y 2115/10; A45F 3/00

(52) U.S. Cl. CPC A45F 3/16; F21V 33/008; F21V 23/04; F21S 9/00; B65D 55/16; B65D 23/102; B65D 43/0204; A45F 2003/001; F21Y 2115/10

(57) ABSTRACT

An improved container for storing liquids includes a main body. The main body includes a front surface, a rear surface, a left side surface, a right side surface, a top surface, a base surface, and plurality of cylindrical surfaces. The top surface includes an aperture adapted to allow liquids to pass therethrough. The front surface, the rear surface, the left side surface, the right side surface, the top surface, and the base surface form an interior volume adapted to retain liquids therein. The plurality of cylindrical surfaces extend between the left side surface and the right side surface.

### CROSS-REFERENCE TO RELATED APPLICATION

The present application is related to and claims priority from prior provisional application Ser. No. 62/351,186, filed Jun. 16, 2016 which application is incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### BACKGROUND OF THE INVENTION

The following includes information that may be useful in understanding the present invention(s). It is not an admission that any of the information provided herein is prior art, or material, to the presently described or claimed inventions, or that any publication or document that is specifically or implicitly referenced is prior art.

### 1. Field of the Invention

The present invention relates generally to the field of water bottle devices and more specifically relates to an improved container for storing liquids comprising finger holes and LED lighting that may be turned on or off via a depressible button.

### 2. Description of the Related Art

A water bottle is a container that may be used to hold water, liquids and other beverages for drinking. A water bottle provides an easy transport of a beverage from one place to another. Many different designs for water bottles are currently available for purchase with different lids, shapes, and functional components. Water bottles can be either disposable or reusable. Reusable water bottles can also be used for liquids such as juice, iced tea, alcoholic beverages, or soft drinks. As such, an improved design for a water bottle is desirable.

Various attempts have been made to solve problems found in water bottle devices art. Among these are found in: U.S. Pat. No. 6,913,159 to Robert H. Goldberg; U.S. Publication No. 2012/0152955 to Thomas Middleton; and U.S. Publication No. 2008/0047924 to William E. Coats. This prior art is representative of gripping water bottle devices.

Ideally, an improved container for storing liquids (also referred to herein as Water Bottle 2.0) should be user-friendly and safe in-use and, yet should operate reliably and be manufactured at a modest expense. Thus, a need exists for an improved container for storing liquids comprising finger holes and LED lighting that may be turned on or off via a depressible button and to avoid the above-mentioned problems

### BRIEF SUMMARY OF THE INVENTION

In view of the foregoing disadvantages inherent in the known water bottle device art, the present invention provides an improved container for storing liquids (also referred to herein as Water Bottle 2.0). The general purpose of the present invention, which will be described subsequently in greater detail is to provide a water bottle devices and more specifically relates to an improved container for storing liquids comprising finger holes and LED lighting that may be turned on or off via a depressible button.

An improved container for storing liquids is disclosed herein in a preferred embodiment comprises a main body. The main body includes a front surface, a rear surface, a left side surface, a right side surface, a top surface, a base surface, and plurality of cylindrical surfaces. The top surface includes an aperture adapted to allow liquids to pass therethrough. The front surface, the rear surface, the left side surface, the right side surface, the top surface, and the base surface form an interior volume adapted to retain liquids therein. The plurality of cylindrical surfaces extend between the left side surface and the right side surface.

The present invention holds significant improvements and serves as a Water Bottle 2.0. For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present invention, Improved Container for Storing Liquids (also referred to herein as Water Bottle 2.0) constructed and operative according to the teachings of the present invention.

FIG. 1 shows a perspective view illustrating an Improved Container for Storing Liquids in an in-use condition according to an embodiment of the present invention.

FIG. 2 is a left side perspective view illustrating the Improved Container for Storing Liquids having a plurality of perforations according to an embodiment of the present invention of FIG. 1.

FIG. 3 is a front side perspective view illustrating the Improved Container for Storing Liquids having a light source, power source, and button member in an uncovered position according to an embodiment of the present invention of FIG. 1.

FIG. 4 is a right-side perspective view illustrating Improved Container for Storing Liquids according to an embodiment of the present invention of FIG. 1.

FIG. 5 is a perspective view illustrating Improved Container for Storing Liquids in a closed position according to an embodiment of the present invention of FIG. 1.

The various embodiments of the present invention will hereinafter be described in conjunction with the appended drawings, wherein like designations denote like elements.

### DETAILED DESCRIPTION

As discussed above, embodiments of the present invention relate to a water bottle device and more specifically relates to an improved container for storing liquids (also referred to herein as Water Bottle 2.0). The general purpose of the present invention, which will be described subsequently in greater detail is to provide a water bottle devices and more specifically relates to an improved container for storing liquids comprising finger holes and LED lighting that may be turned on or off via a depressible button.

Generally speaking, the improved container for storing liquids of the present invention may comprise a lid, a body, and LED lighting. The body comprising a semi ellipse front surface, an obtuse angled rear surface, a left side surface, a right side surface, four small cylindrical surfaces, a base surface, and a top surface. Four perforations may be disposed on the left side surface and a right side surface penetrating there through. The four perforations may reside within the interior of the four small cylindrical surfaces, creating four finger holes.

The four perforations may be large enough to allow a user to insert their four fingers there through, enabling a user to grasp or engage the container. The four perforations may not penetrate into the interior of the container, such that the container may not leak water out of the perforations when filled with liquid.

The lid of the container of the present invention may comprise a snap fit fastener, such that the lid may snap closed and provide a water tight seal. The lid of the container may comprise a substantially rectangular profile and a flexible attachment member. A rectangular male portion may be disposed on the top surface of the body of the container, and may allow the lid of the container to snap fasten around the outer periphery thereof. The flexible attachment member may bend to allow the lid to rotate to an open or closed position.

With the lid is in a closed position, the ellipse front surface, obtuse angled rear surface, left side surface, right side surface, four cylindrical surfaces, base surface, and top surface of the body in combination with the lid may provide a water tight container.

The LED lighting of the container may comprise LED lights disposed on an exterior portion of the body of the present invention. The LED lighting may turn on or off via a push activated button disposed on an exterior portion of the body of the present invention. When the LED lighting is turned on, the contents of the present invention may light up; as such the present invention may be useful for drinking a beverage in the dark.

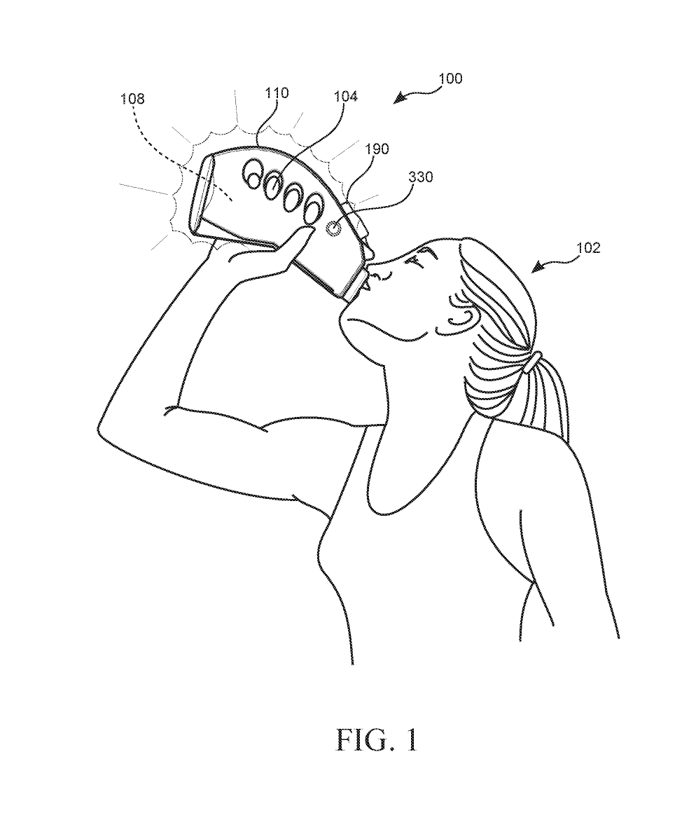

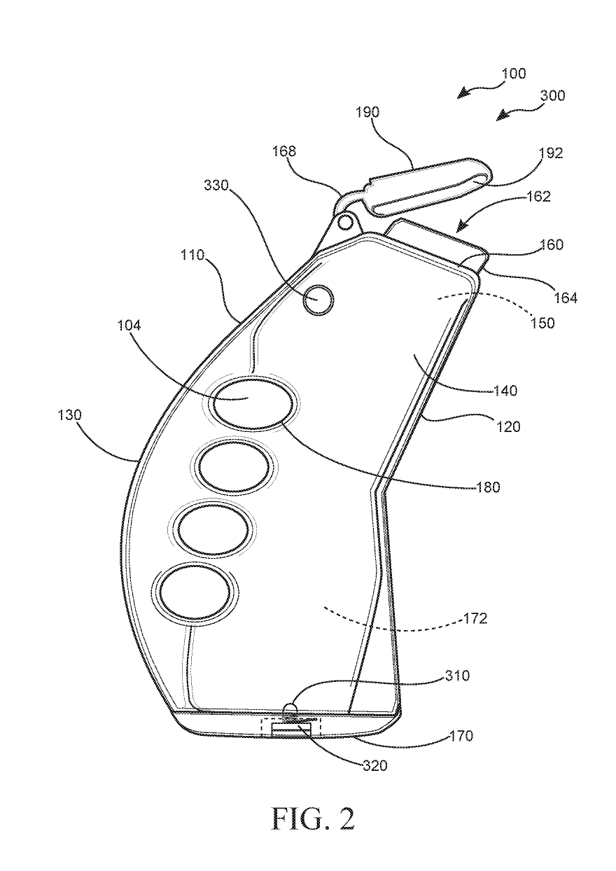

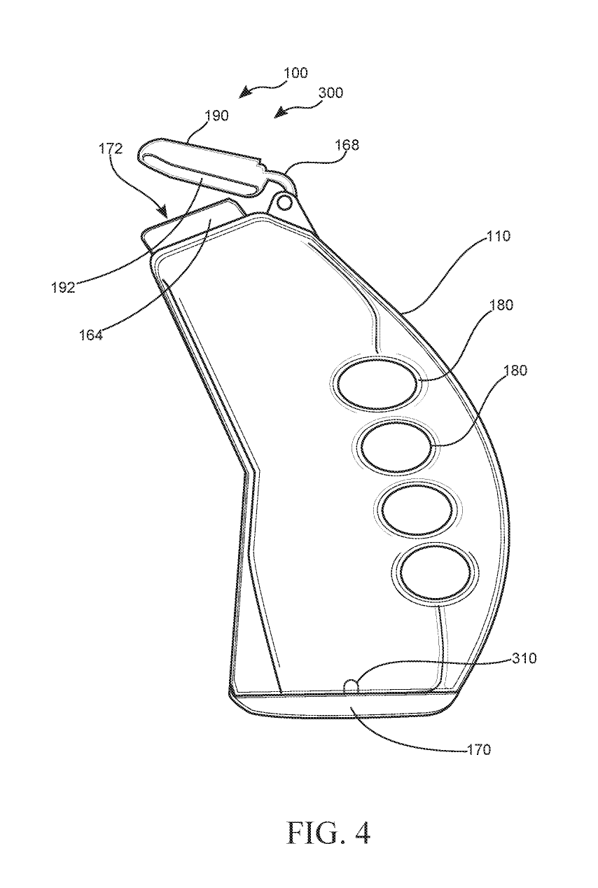

Referring now to FIGS. 1-5, showing perspective views improved container 100 for storing liquids according to an embodiment of the present invention of FIG. 1.

Improved container 100 for storing liquids is disclosed herein in a preferred embodiment comprises main body 110. Main body 110 includes front surface 120, rear surface 130, left side surface 140, right side surface 150, top surface 160, base surface 170, and plurality of cylindrical surfaces 180. Main body 110 has a substantially rectangular shape. Main body 110 is adapted to be water tight. Main body 110 is formed from a material chosen from a list of materials consisting on plastic and acrylic.

Front surface 120, rear surface 130, left side surface 140, right side surface 150, top surface 160, and base surface 170 form interior volume 172 adapted to retain liquids 108 therein. Front surface 120 is formed having a semi-elliptical shape. Rear surface 130 extends at an obtuse angle with respect to base surface 170. Top surface 160 includes aperture 162 adapted to allow liquids to pass therethrough.

Left side surface 140 and right side surface 150 include plurality of perforations 144 therethrough. There are preferably four of perforations 144. Plurality of cylindrical surfaces 180 extend between respective left side surface 140 and right side perforations 144 and are adapted to allow fingers 104 of user 102 to pass therethrough as shown in in-use condition 106 of FIG. 1. Plurality of cylindrical surfaces 180 extend between left side surface 140 and right side surface 150. There are four of cylindrical surfaces 180.

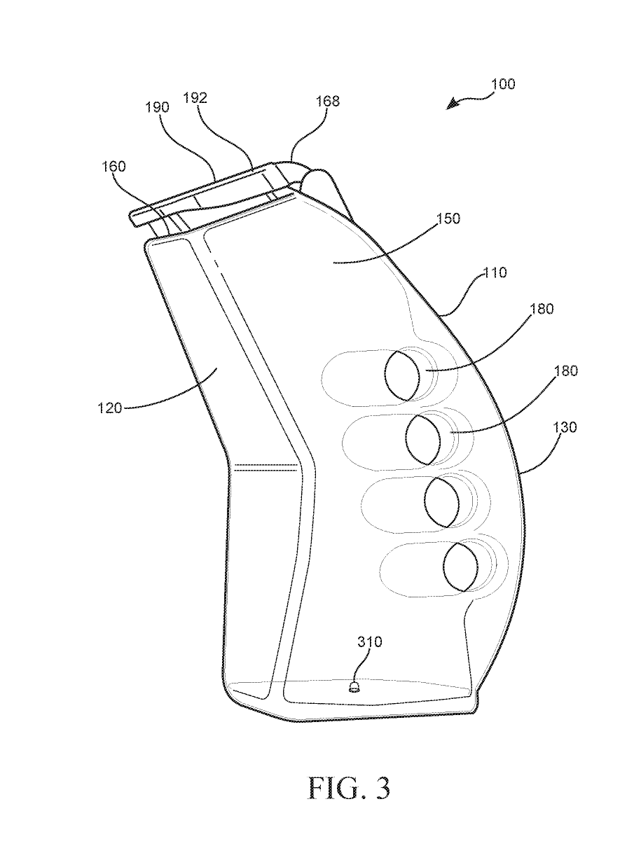

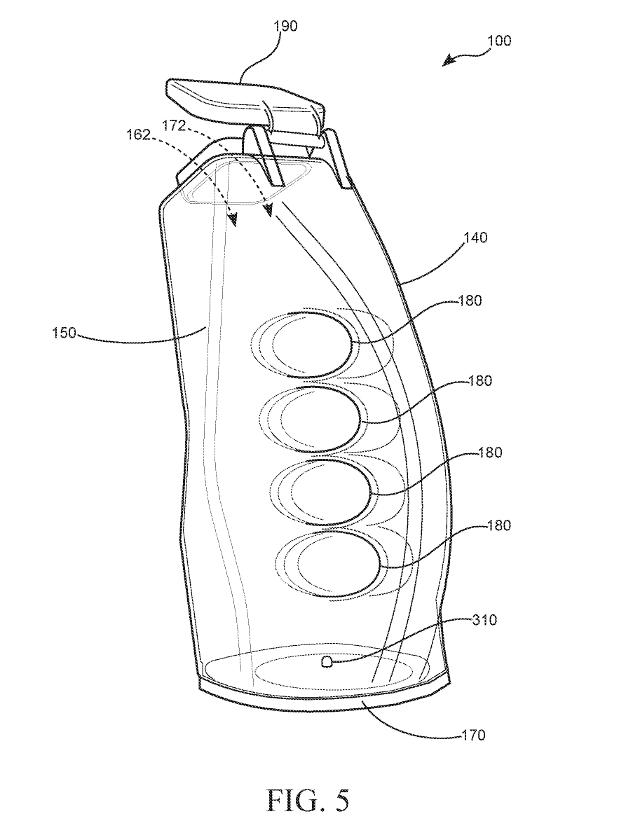

Improved container 100 further comprising lid member 190 releasably attached to top surface 160 and adapted to releasably cover aperture 162. Lid member 190 is adapted to snap fit upon aperture 162. Aperture 162 includes male member 164 extending outwardly therefrom; and lid member 190 includes female member 192 adapted to releasably engage with male member 164 as shown in FIG. 5. Improved container 100 comprising flexible attachment member 168 connected between lid member 190 and top surface 160 and is adapted to bias lid member 190 between covered position 500 and uncovered position 300 of FIG. 3.

Improved container 100 further comprising light source 310 adapted to illuminate interior volume 172 and any liquid retained therein. Improved container 100 further comprising light source 310 is formed as a light emitting diode. Light source 310 is located on one of front surface 120, rear surface 130, left side surface 140, and right side surface 150. Improved container 100 further comprising power source 320 adapted to provide power to light source 310; and button member 330 adapted to turn on and off power source 320.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. An improved container for storing liquids, comprising:
a main body including:
a front surface;
a rear surface;
a left side surface;
a right side surface;
a top surface;
wherein said top surface includes an aperture adapted to allow liquids to pass therethrough;
a base surface;
wherein said front surface, said rear surface, said left side surface, said right side surface; said top surface, and said base surface form an interior volume adapted to retain liquids therein; and
a plurality of cylindrical surfaces;
wherein said plurality of cylindrical surfaces extend between said left side surface and said right side surface.

2. The improved container of claim 1, wherein said left side surface and said right side surface include a plurality of perforations therethrough; and wherein said plurality of cylindrical surfaces extend between respective left and right side perforations and are adapted to allow a user's fingers to pass therethrough.

3. The improved container of claim 1, further comprising a lid member releasably attached to said top surface and adapted to releasably cover said aperture.

4. The improved container of claim 3, wherein said lid member is adapted to snap fit upon said aperture.

5. The improved container of claim 1, wherein said front surface is formed having a semi-elliptical shape.

6. The improved container of claim 5, wherein said rear surface is extends at an obtuse angle with respect to said base surface.

7. The improved container of claim 3, further comprising a light source adapted to illuminate said interior volume and any liquid retained therein.

8. The improved container of claim 7, further comprising a light source is formed as a light emitting diode.

9. The improved container of claim 8, further comprising a power source adapted to provide power to said light source; and a button member adapted to turn on and off said power source.

10. The improved container of claim 3, further comprising a flexible attachment member connected between said lid member and said top surface and is adapted to bias said lid member between a covered and uncovered position.

11. The improved container of claim 4, wherein said aperture includes a male member extending outwardly therefrom; and said lid member includes a female member adapted to releasably engage with said male portion.

12. The improved container of claim 1, wherein said main body has a substantially rectangular shape.

13. The improved container of claim 1, wherein said main body is formed from a material chosen from a list of materials consisting on plastic and acrylic.

14. The improved container of claim 7, wherein said light source is located on one of said front surface, said rear surface, said left side surface, and said right side surface.

15. The improved container of claim 13, wherein said main body is adapted to be water tight.

16. The improved container of claim 1, wherein there are four of said cylindrical surfaces.

17. The improved container of claim 16, wherein there are four of said perforations.
